(19) United States
(12) Patent Application Publication
(10) Pub. No.: US 2013/0298220 A1
(43) Pub. Date: Nov. 7, 2013

(54) SYSTEM AND METHOD FOR MANAGING FILTERING INFORMATION OF ATTACK TRAFFIC

(71) Applicant: ELECTRONICS AND TELECOMMUNICATIONS RESEARCH INSTITUTE, Daejeon (KR)

(72) Inventors: Hyeonsik YOON, Daejeon (KR); Kyoung-Soon KANG, Daejeon (KR); Yoo Hwa KANG, Daejeon (KR); Hyunjoo KANG, Daejeon (KR); Hak Suh KIM, Daejeon (KR); Byungjun AHN, Daejeon (KR); Kyeong-Ho LEE, Daejeon (KR); Ki Cheol JEON, Daejeon (KR); Boo Geum JUNG, Daejeon (KR); Hea Sook PARK, Daejeon (KR); Soon Seok LEE, Daejeon (KR)

(73) Assignee: Electronics and Telecommunications Research Institute, Daejeon (KR)

(21) Appl. No.: 13/747,776

(22) Filed: Jan. 23, 2013

(30) Foreign Application Priority Data
May 7, 2012 (KR) 10-2012-0048001

(51) Int. Cl. H04L 29/06

(52) U.S. Cl. CPC H04L 63/0245
USPC 726/12; 726/11

(57) ABSTRACT

The present disclosure relates to a system and a method for managing filtering information of attack traffic, and more particularly, to a system and a method for managing filtering information of attack traffic that may block attack traffic in a front end from which the attack traffic is transmitted by transmitting traffic filtering information, to a first autonomous system of the front end from which the attack traffic is transmitted, through a border gateway protocol (BGP) and by applying, to a relevant router, the transmitted traffic filtering information in the corresponding first autonomous system, when an edge router of a second autonomous system (AS) positioned in a rear end sets the traffic filtering information by detecting the attack traffic.

### CROSS-REFERENCE TO RELATED APPLICATIONS

This application is based on and claims priority from Korean Patent Application No. 10-2012-0048001, filed on May 7, 2012, with the Korean Intellectual Property Office, the disclosure of which is incorporated herein in its entirety by reference.

### TECHNICAL FIELD

The present disclosure relates to a system and a method for managing filtering information of attack traffic, and more particularly, to a system and a method for managing filtering information of attack traffic that may block attack traffic in a front end from which the attack traffic is transmitted by transmitting traffic filtering information, to a first autonomous system of the front end from which the attack traffic is transmitted, through a border gateway protocol (BGP) and by applying, to a relevant router, the transmitted traffic filtering information in the corresponding first autonomous system, when an edge router of a second autonomous system (AS) positioned in a rear end sets the traffic filtering information by detecting the attack traffic.

### BACKGROUND

With current increasing popularity of the Internet, an infection path of malicious software or a malicious code over a communication network has been diversified. Damage coming from the above malicious software or malicious code has been increasing every year. The malicious code refers to software that is intentionally produced to perform malicious activities such as destroying a system, leaking information, and the like, against intent or interest of a user. Types of malicious codes include hacking tools such as virus, worm, Trojan, backdoor, and the like, malicious spyware, ad-ware, and the like. The above malicious codes include a self-duplication function or an automatic reproduction function and thereby cause problems such as leakage of personal information such as a user identifier (ID), a password, and the like, control of a target system, file delete and change/system destruction, service denial of an application program/system, leakage of key data, installation of another hacking program, and the like. Accordingly, relevant damage is various and serious.

As damage occurring due to the above malicious software or malicious code, damage by distributed denial of service (DDoS) has currently appeared as a serious issue. A DDoS attack is one of hacking schemes and makes it impossible for a system to provide a normal service any more by distributing and arranging a plurality of attackers to thereby simultaneously make denial of service attacks.

The DDoS attack is also generally referred to as a distributed denial of service attack and is one of hacking schemes that attacks a predetermined site by distributing and arranging a plurality of attackers to thereby simultaneously operate. The DDoS attack implants tools for service attack in a plurality of computers and enables a significantly huge amount of packets that a computer system of a site, an attacking target, is incapable of processing to simultaneously flow, thereby degrading performance of a network or paralyzing the computer system. Accordingly, a user may not normally access the computer system and if even worse, a function of a main computer may be exposed to critical damage. A large number of computer systems may be utilized as a host of hacking without knowledge of the user. In general, the above attack is performed in a predetermined time zone by infecting a PC of a general user using a malicious code, an email, and the like, and thereby making the PC into so-called Zombie PC and then using control of a Botnet Command & Control (C&C) server.

In preparation for the above network damage, a defensive action against the DDoS attack has been currently taken using a variety of schemes. Among the variety of schemes, a representative attack traffic defending method inputs, into a router, an Internet protocol (IP) of attack traffic occurring in Botnet or a Zombie PC, so that the corresponding traffic may flow in attack traffic inspection and blocking equipment. Next, through a precise inspection, the attack traffic is blocked and normal traffic is transmitted to an original destination.

As described above, in general, in the case of detecting attack traffic represented by the DDoS attack, a corresponding system and network filter relevant attack traffic, or take a defensive action against the attack traffic.

Through the attack traffic defending method in the related art, stability of a corresponding network is secured. However, a network of a front end that transmits the attack traffic to a corresponding network does not recognize the presence of the corresponding attack traffic. An autonomous system (AS) of the front end that does not recognize the presence of the corresponding attack traffic continuously transmits, to an autonomous system of a rear end, the attack traffic to be blocked. That is, the autonomous system of the rear end filers attack traffic and also continuously receives, from the autonomous system of the front end, attack traffic that does not need to be transmitted. Accordingly, the network of the front end continuously transmits traffic that does not need to be transmitted, while wasting network resources.

The attack traffic defending method in the related art blocks attack traffic using only IP information of the corresponding attack traffic and thus, cannot control various traffic flows. To block attack traffic, the attack traffic defending method in the related art inputs IP information of corresponding traffic into a routing table. However, in this case, routing information and filtering information is mixed in the routing table.

### SUMMARY

The present disclosure has been made in an effort to provide a system and a method for managing filtering information of attack traffic that may block attack traffic in a front end from which attack traffic is transmitted by transmitting traffic filtering information, to a first autonomous system of the front end from which the attack traffic is transmitted, through a border gateway protocol and by applying, to a relevant router, the transmitted traffic filtering information in the corresponding first autonomous system, when an edge router of a second autonomous system positioned in a rear end sets the traffic filtering information by detecting the attack traffic, and thereby may prevent waste of network resources for transmission of unnecessary traffic.

The present disclosure enables further precise traffic filtering by transmitting traffic filtering information that includes not only an Internet protocol (IP) address but also flow information capable of further accurately classifying traffic.

The present disclosure has been made in an effort to provide a system and a method for managing filtering information of attack traffic that may easily distinguish routing information and filtering information by storing traffic filtering information in not a routing table but a filtering table.

An exemplary embodiment of the present disclosure provides a system including: a second edge router positioned within a second autonomous system to detect attack traffic from input traffic according to a predetermined policy, to block the detected attack traffic by setting traffic filtering information corresponding to the detected attack traffic, and to transmit the set traffic filtering information to a first autonomous system; and a first edge router positioned within the first autonomous system to set, in an interface, traffic filtering information received from the second edge router, and to transmit the set traffic filtering information to another edge router within the first autonomous system. The first autonomous system is positioned in a front end of the second autonomous system.

Another exemplary embodiment of the present disclosure provides a method including: detecting, by a second edge router positioned within a second autonomous system, attack traffic from input traffic according to a predetermined policy; setting, by the second edge router, traffic filtering information corresponding to the detected attack traffic; blocking, by the second edge router, the detected attack traffic based on the set traffic filtering information; and transmitting, by the second edge router, the set traffic filtering information to a first autonomous system.

Another exemplary embodiment of the present disclosure provides a method including: setting, by a first edge router positioned within the first autonomous system, traffic filtering information received from the second edge router in an interface; transferring, by the first edge router, the set traffic filtering information to another edge router within the first autonomous system; detecting, by the first edge router, attack traffic based on the set traffic filtering information; and blocking, by the first edge router, the detected attack traffic based on the set traffic filtering information.

According to the exemplary embodiments of the present disclosure, when an edge router of a second autonomous system positioned in a rear end sets traffic filtering information by detecting attack traffic, it is possible to block the attack traffic in a front end from which attack traffic is transmitted by transmitting traffic filtering information, to a first autonomous system of the front end from which the attack traffic is transmitted, through a border gateway protocol and by applying, to a relevant router, the transmitted traffic filtering information in the corresponding first autonomous system, and it is possible to prevent waste of network resources for transmission of unnecessary traffic.

According to the exemplary embodiments of the present disclosure, further precise traffic filtering is enabled by transmitting traffic filtering information that includes not only an IP address but also flow information capable of further accurately classifying traffic.

According to the exemplary embodiments of the present disclosure, it is possible to easily distinguish routing information and filtering information by storing traffic filtering information in not a routing table but a filtering table.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a configuration diagram illustrating a system for managing filtering information of attack traffic according to an exemplary embodiment of the present disclosure.

FIG. 2 is a block diagram illustrating an edge router C of FIG. 1 according to an exemplary embodiment of the present disclosure.

FIG. 3 is a block diagram illustrating an edge router B of FIG. 1 according to an exemplary embodiment of the present disclosure.

FIG. 4 is a flowchart illustrating a method of managing filtering information of attack traffic in the edge router C according to an exemplary embodiment of the present disclosure.

FIG. 5 is a flowchart illustrating a method of managing filtering information of attack traffic in the edge router B according to an exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

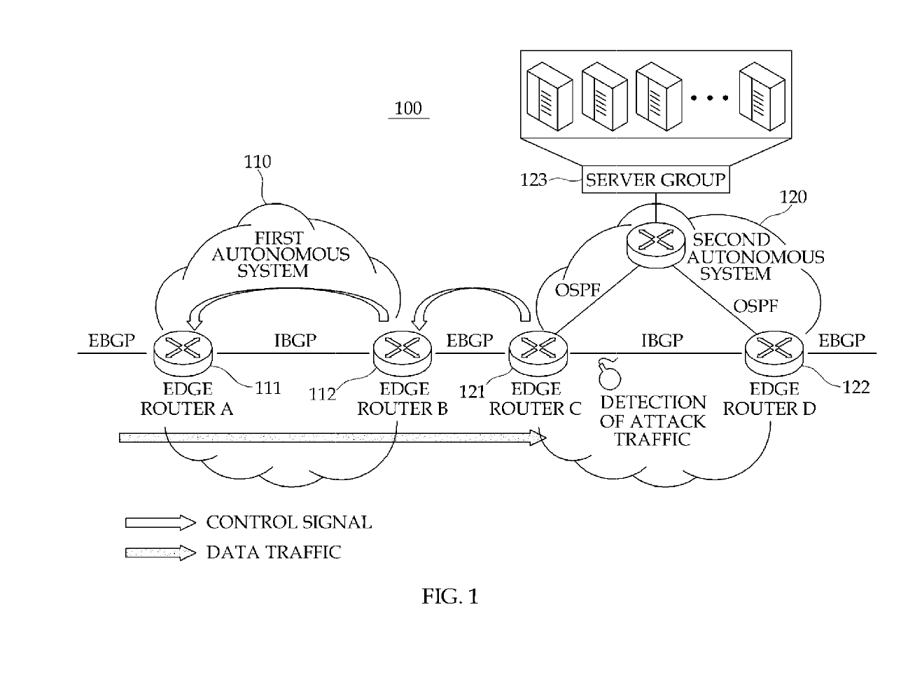

FIG. 1 is a configuration diagram illustrating a system for managing filtering information of attack traffic according to an exemplary embodiment of the present disclosure.

As shown in FIG. 1, the system 100 for managing filtering information of attack traffic includes a first autonomous system 110 and a second autonomous system 120. The first autonomous system 110 includes an edge router A 111 and an edge router B 112. The second autonomous system 120 includes an edge router C 121, an edge router D 122, and a server group 123. The first autonomous system 110 is positioned in a front end of the second autonomous system 120 to transmit traffic to the second autonomous system 120.

The first autonomous system 110 and the second autonomous system 120 are connected to each other through the edge router B 112 and the edge router C 121. The first autonomous system 110 and the second autonomous system 120 exchange routing information of the respective autonomous systems through an external border gateway protocol (EBGP). Edge routers (for example, the edge router A 111 and the edge router B 112, or the edge router C 121 and the edge router D 122) within the same autonomous system exchange routing information through an internal border gateway protocol (IBGP). Routers within each autonomous system exchange routing information using an open shortest path first (OSPF) that is an internal gateway protocol (IGP), an intermediate system to intermediate system (IS-IS), a routing information protocol (RIP), and the like.

Hereinafter, each of constituent elements of the first autonomous system 110 and the second autonomous system 120 that are included in the system 100 for managing filtering information of attack traffic according to the present disclosure will be described.

The edge router C 121 is positioned within the second autonomous system 120. The edge router C 121 detects attack traffic from traffic input from the first autonomous system 110 according to a predetermined policy, and blocks the detected attack traffic by setting traffic filtering information corresponding to the detected attack traffic. The edge router C 121 transmits the set traffic filtering information to the first autonomous system 110.

For example, the edge router C 121 detects a distributed denial of service (DDoS) attack and secures attack traffic information corresponding to the DDoS attack. Next, to secure stability of a network, the edge router C 121 sets corresponding traffic filtering information in an interface of the edge router C 121 into which corresponding attack traffic is input.

In this instance, the traffic filter information includes an IP address, a protocol identifier (ID), source port number information, destination port number information, Internet control message protocol (ICMP) type information, ICMP code information, and the like that are capable of classifying a flow of corresponding traffic. The edge router C 121 transmits traffic filtering information through a border gateway protocol (BGP) between neighboring routers. For example, a transmission method of traffic filtering information may follow an Internet engineering task force (IETF) RFC 5575 standard.

Meanwhile, the edge router B 112 is positioned within the first autonomous system 110. The edge router B 112 sets, in an interface, traffic filtering information received from the edge router C 121. That is, after traffic filtering information is transmitted from the edge router C 121, the edge router B 112 sets relevant traffic filtering information in an input interface into which attack traffic is input. The edge router B 112 transmits the set traffic filtering information to another edge router within the first autonomous system 110. That is, the edge router B 112 transfers the traffic filtering information to all of the routers in which a BGP connection is set, excluding the edge router C 121 of the second autonomous system 120 from which the traffic filtering information is received.

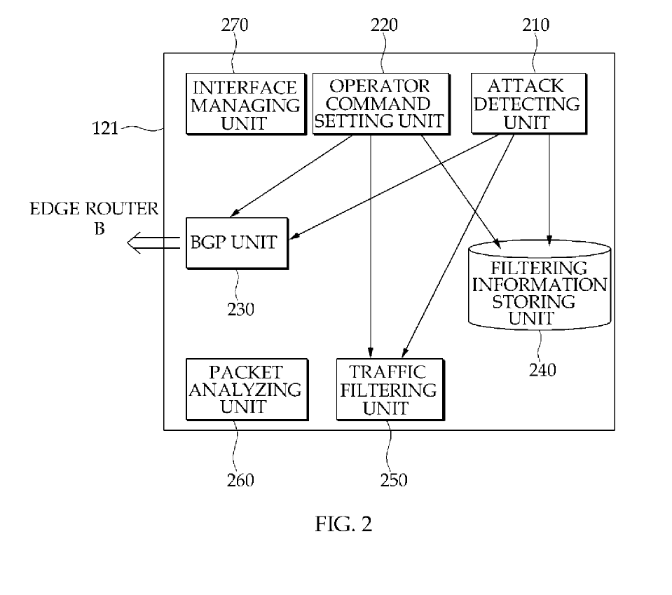

FIG. 2 is a block diagram illustrating the edge router C 121 of FIG. 1 according to an exemplary embodiment of the present disclosure.

As shown in FIG. 2, the edge router C 121 includes an attack detecting unit 210, an operator command setting unit 220, a BGP unit 230, a filtering information storing unit 240, a traffic filtering unit 250, a packet analyzing unit 260, and an interface managing unit 270.

The attack detecting unit 210 detects attack traffic from traffic input from the edge router C 121 according to a predetermined policy, and sets traffic filtering information corresponding to the detected attack traffic. For example, the attack detecting unit 210 sets traffic filtering information to be blocked by analyzing traffic information that is determined to be a DDoS attack.

The operator command setting unit 220 receives a command associated with router setting, and sets traffic filtering information.

The BGP unit 230 processes a function associated with a BGP. The BGP unit 230 transmits, to the edge router B 112 positioned within the first autonomous system 110, traffic filtering information set by the attack detecting unit 210 or the operator command setting unit 220. In this instance, the BGP unit 230 transmits the traffic filtering information to the edge router B 112 that includes a neighboring peer BGP module.

The filtering information storing unit 240 stores traffic filtering information set by the attack detecting unit 210 or the operator command setting unit 220. In this instance, the filtering information storing unit 240 may easily distinguish routing information and filtering information by storing the traffic filtering information in not a routing table but a filtering table. When previously stored traffic filtering information is modified, the filtering information storing unit 240 updates and thereby stores the modified traffic filtering information.

The traffic filtering unit 250 blocks attack traffic detected by the attack detecting unit 210, based on traffic filtering information set by the attack detecting unit 210 or the operator command setting unit 220.

The packet analyzing unit 260 performs a deep packet inspection (DPI) function. To detect traffic corresponding to the received traffic filtering information, the packing analyzing unit 260 analyzes at last one of IP address information of traffic, a protocol ID, source port number information, destination port number information, ICMP type information, and ICMP code information. Through the above operation, the packet analyzing unit 260 may identify a traffic flow as well as IP address information of traffic.

The interface managing unit 270 may manage physical and logical interface information of the edge router C 121.

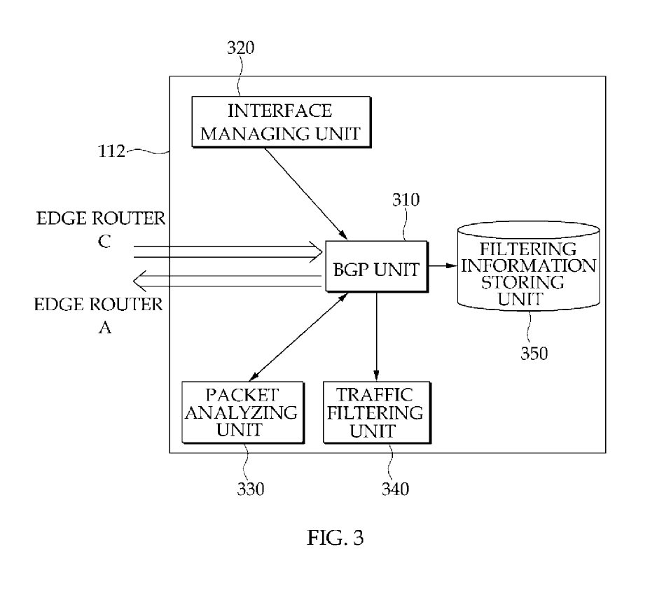

FIG. 3 is a block diagram illustrating the edge router B 112 of FIG. 1 according to an exemplary embodiment of the present disclosure.

As shown in FIG. 3, the edge router B 112 includes a BGP unit 310, an interface managing unit 320, a packet analyzing unit 330, a traffic filtering unit 340, and a filtering information storing unit 350.

The BGP unit 310 sets, in an interface, traffic filtering information received from the edge router C 121 positioned within the second autonomous system 120. Specifically describing, the BGP unit 310 requests the interface managing unit 320 for information about an operating interface in addition to an input interface. When the operating interface is present, the BGP unit 310 requests the packet analyzing unit 330 for information about an interface into which corresponding attack traffic is input.

As a result of the above request, when an interface into which attack traffic corresponding to traffic filtering information is input is present, the BGP unit 310 sets the traffic filtering information in the corresponding interface. On the contrary, when the interface into which attack traffic is input is currently absent, the BGP unit 310 sets the traffic filtering information in all of the operating interfaces.

Next, the BGP unit 310 verifies whether an edge router in which a peer BGP module operates is present, in addition to the edge router C 121 from which traffic filtering information about the attack traffic is received.

If another edge router is present, the BGP unit 310 transfers the traffic filtering information to the corresponding edge router. That is, the BGP unit 310 transmits the set traffic filtering information to the edge router A 111 that is another edge router within the first autonomous system 110. On the contrary, when another edge router is absent, the BGP unit 310 terminates an operation.

Here, the interface managing unit 320 manages physical and logical interface information.

To detect traffic corresponding to the received traffic filtering information, the packet analyzing unit 330 analyzes at least one of IP address information of traffic, a protocol ID, source port number information, destination port number information, ICMP type information, and ICMP code information.

The traffic filtering unit 340 blocks the detected attack traffic, based on traffic filtering information set by the BGP unit 310.

The filtering information storing unit 350 stores traffic filtering information. In this instance, the filtering information storing unit 350 may easily distinguish routing information and filtering information by storing the traffic filtering information in not a routing table but a filtering table. The filtering information storing unit 350 updates and thereby stores the traffic filtering information received from the BGP unit 310.

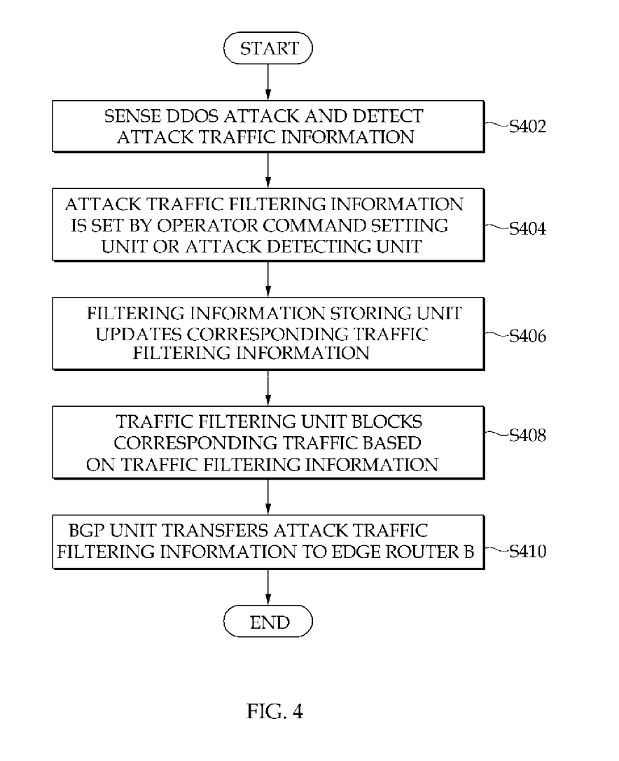

FIG. 4 is a flowchart illustrating a method of managing filtering information of attack traffic in the edge router C according to an exemplary embodiment of the present disclosure.

The attack detecting unit 210 senses a DDoS attack and detects attack traffic information corresponding to the DDoS attack (S402).

Attack traffic filtering information is set by the operator command setting unit 220 or the attack detecting unit 210 (S404).

The filtering information storing unit 240 updates and thereby stores corresponding traffic filtering information (S406).

The traffic filtering unit 250 blocks attack traffic based on the traffic filtering information (S408).

The BGP unit 230 transfers the attack traffic filtering information to the edge router B 112 (S410).

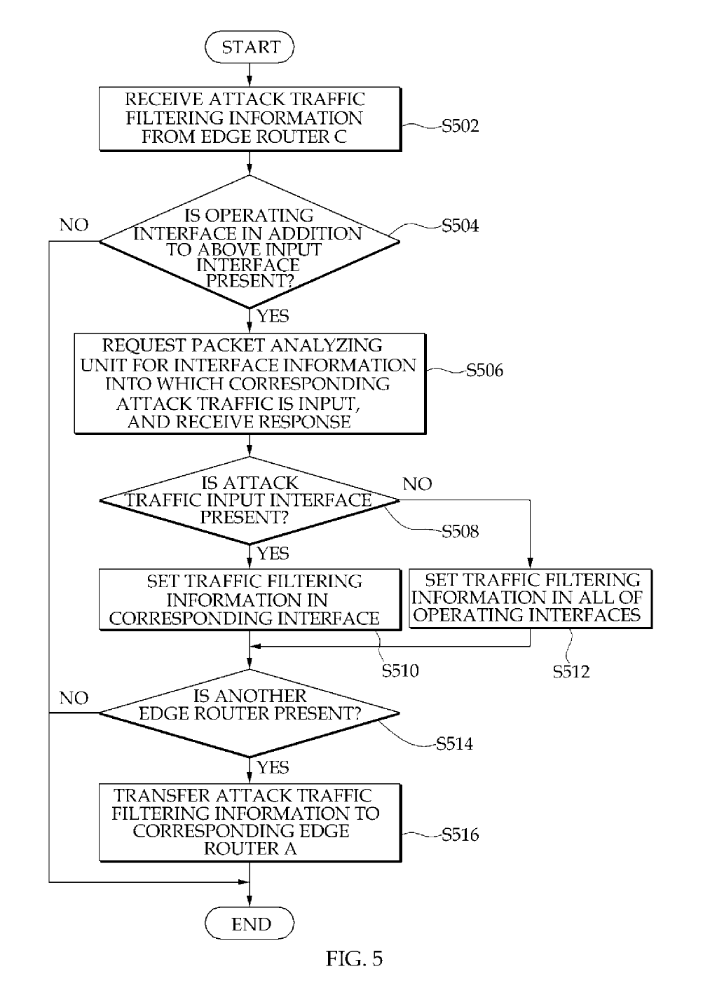

FIG. 5 is a flowchart illustrating a method of managing filtering information of attack traffic in the edge router B according to an exemplary embodiment of the present disclosure.

The BGP unit 310 receives attack traffic filtering information from the edge router C 121 (S502).

The BGP unit 310 verifies whether an operating interface is present in addition to the above input interface connected to the edge router C 121(S504).

When the operating interface is present as the verification result (S504), the BGP unit 310 requests the packet analyzing unit 330 about whether interface information into which corresponding attack traffic is input is present, and receives a response thereto (S506). On the contrary, when the operating interface is absent, the BGP unit 310 terminates an attack traffic managing process.

The BGP unit 310 verifies, from the received response (S506), whether an attack traffic input interface is present (S508).

When the attack traffic input interface is present as the verification result (S508), the BGP unit 310 sets traffic filtering information in a corresponding interface (S510). On the contrary, when the attack traffic input interface is absent, the BGP unit 310 sets the traffic filtering information in all of the interfaces (S512).

The BGP unit 310 verifies whether another edge router is present (S514).

When another edge router is present as the verification result (S514), the BGP unit 310 transfers attack traffic filtering information to the corresponding edge router A 111 (S516). On the contrary, when another edge router is absent, the BGP unit 310 terminates a traffic filtering information managing process.

The present disclosure may block attack traffic in a front end from which attack traffic is transmitted by transmitting traffic filtering information to a first autonomous system of the front end from which the attack traffic is transmitted through a BGP, and by applying, to a relevant router, the transmitted traffic filtering information in the corresponding first autonomous system, when an edge router of a second autonomous system positioned in a rear end sets traffic filtering information by detecting attack traffic, and thereby may prevent waste of network resources for transmission of unnecessary traffic. In this aspect, the present disclosure is beyond limit of the existing art and thus, may be employed for the related art and may also have a sufficient probability for release or business of an apparatus to be applied with the present disclosure. The present disclosure may be realistically clearly implemented. Accordingly, the present disclosure has a promising industrial applicability.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A system for managing filtering information of attack traffic, the system comprising:
a second edge router positioned within a second autonomous system configured to detect attack traffic from input traffic according to a predetermined policy, block the detected attack traffic by setting traffic filtering information corresponding to the detected attack traffic and transmit the set traffic filtering information to a first autonomous system; and
a first edge router positioned within the first autonomous system configured to set, in an interface, traffic filtering information received from the second edge router and transmit the set traffic filtering information to another edge router within the first autonomous system,
wherein the first autonomous system is positioned in a front end of the second autonomous system.

2. The system of claim 1, wherein the second edge router comprises:
a filtering information storing unit configured to store traffic filtering information;
an interface managing unit configured to manage physical and logical interface information;
an attack detecting unit configured to detect attack traffic from input traffic according to the predetermined policy and set traffic filtering information corresponding to the detected attack traffic;
a border gateway protocol unit configured to transmit the set traffic filtering information to the first autonomous system; and
a traffic filtering unit configured to block the detected attack traffic based on the set traffic filtering information.

3. The system of claim 2, further comprising:
an operator command setting unit configured to receive a command associated with router setting from an operator, and to set traffic filtering information.

4. The system of claim 1, wherein the first edge router comprises:
a filtering information storing unit configured to store traffic filtering information;
an interface managing unit configured to manage physical and logical interface information;
a border gateway protocol unit configured to set, in an interface, traffic filtering information received from the second edge router and transmit the set traffic filtering information to another edge router within the first autonomous system; and
a traffic filtering unit configured to block the detected attack traffic based on the set traffic filtering information.

5. The system of claim 4, wherein:
when an interface into which attack traffic corresponding to the received traffic filtering information is input is present among operating interfaces, the border gateway protocol unit sets traffic filtering information in a corresponding input interface, and
when the interface into which attack traffic corresponding to the received traffic filtering information is input is absent, the border gateway protocol unit sets traffic filtering information in all of the interfaces.

6. The system of claim 4, further comprising:
a packet analyzing unit to analyze at least one of Internet protocol (IP) address information of traffic, a protocol identifier (ID), source port number information, destination port number information, Internet control message protocol (ICMP) type information, and ICMP code information in order to detect traffic corresponding to the received traffic filtering information.

7. The system of claim 4, wherein the filtering information storing unit stores traffic filtering information in not a routing table but a filtering table in order to distinguish routing information and filtering information.

8. A method of managing filtering information of attack traffic, the method comprising:
detecting, by a second edge router positioned within a second autonomous system, attack traffic from input traffic according to a predetermined policy;
setting, by the second edge router, traffic filtering information corresponding to the detected attack traffic;
blocking, by the second edge router, the detected attack traffic based on the set traffic filtering information; and
transmitting, by the second edge router, the set traffic filtering information to a first autonomous system.

9. The method of claim 8, further comprising:
receiving, by the second edge router, a command associated with router setting from an operator,
wherein the setting sets traffic filtering information in response to the received command associated with the router setting.

10. The method of claim 8, further comprising:
analyzing, by the second edge router, at least one of IP address information of traffic, a protocol ID, source port number information, destination port number information, ICMP type information, and ICMP code information in order to detect traffic corresponding to the received traffic filtering information.

11. A method of managing filtering information of attack traffic, the method comprising:
setting, by a first edge router positioned within the first autonomous system, traffic filtering information received from the second edge router in an interface;
transferring, by the first edge router, the set traffic filtering information to another edge router within the first autonomous system;
detecting, by the first edge router, attack traffic based on the set traffic filtering information; and
blocking, by the first edge router, the detected attack traffic based on the set traffic filtering information.

12. The method of claim 11, wherein the setting, by the first edge router, sets traffic filtering information in a corresponding input interface when an interface into which attack traffic corresponding to the received traffic filtering information is input is present among operating interfaces, and sets traffic filtering information in all of the interfaces when the interface into which attack traffic corresponding to the received traffic filtering information is input is absent.

13. The method of claim 10, further comprising:
analyzing, by the first edge router, at least one of IP address information of traffic, a protocol ID, source port number information, destination port number information, ICMP type information, and ICMP code information in order to detect traffic corresponding to the received traffic filtering information.
